(19) United States
(12) Patent Application Publication
(10) Pub. No.: US 2025/0006956 A1
(43) Pub. Date: Jan. 2, 2025

(54) Film Assembly and Manufacturing Method Therefor, Fuel Cell Unit, and Fuel Cell Pack

(71) Applicants: Xiaogang Hao, Shanghai (CN); Robert Bosch GmbH, Stuttgart (DE)

(72) Inventors: Xiaogang Hao, Shanghai (CN); Xu Xie, Shanghai (CN); Jingjun Zhang, Shanghai (CN)

(21) Appl. No.: 18/709,561

(22) PCT Filed: Nov. 15, 2021
(86) PCT No.: PCT/CN2021/130602

§ 371 Date: May 13, 2024

(51) Int. Cl. H01M 8/0273; H01M 8/0284; H01M 8/0286; H01M 8/10; H01M 8/1004; H01M 8/242

(52) U.S. Cl. CPC H01M 8/0273; H01M 8/0284; H01M 8/0286; H01M 8/1004; H01M 8/242; H01M 2008/1095

(57) ABSTRACT

A membrane module and a manufacturing method thereof, a fuel cell unit and a fuel cell package are disclosed. The membrane module includes (i) a multilayer membrane, (ii) a first frame and a second frame substantially located on opposite sides of the multilayer membrane on the plane in which the multilayer membrane is located, and (iii) an elastomeric seal connecting the multilayer membrane with the first frame and the second frame. The fuel cell unit has a simplified structure and is more convenient to manufacture.

### TECHNICAL FIELD

The present disclosure relates to the field of fuel cells. More specifically, it relates to a new membrane module and a manufacturing method thereof, a fuel cell unit, and a fuel cell package.

### BACKGROUND ART

The proton exchange membrane fuel cell is a technologically mature fuel cell stack. The fuel cell stack comprises a membrane electrode assembly (MEAs), bipolar plates (BPP), and a clamp, which form a cell stack once assembled.

FIG. 1 shows an exploded view of an existing proton-exchange membrane fuel cell unit, which sequentially comprises the following from inside to outside: bipolar plates 11, 12, seals 13, 14, frames 17, 18, diffusion layers 15, 16, catalyst layers 16, 19 and a proton-exchange membrane 21. In the manufacturing process of such a fuel cell unit, the seals 13, 14 are formed respectively on the bipolar plates 11, 12, while the two frames 17, 18 are used to hermetically connect the intermediate diffusion layers 15, 16, the catalyst layers 16, 19, and the proton exchange membrane 21 together.

### SUMMARY OF THE INVENTION

The purpose of the present disclosure is to solve or at least alleviate the problems existing in the prior art.

In one aspect, a membrane module is provided, comprising:
a multilayer membrane;
a first frame and a second frame substantially located on opposite sides of the multilayer membrane on the plane in which the multilayer membrane is located; and an elastomeric seal connecting the multilayer membrane with the first frame and the second frame.

Also provided are a manufacturing method of such a membrane module, as well as a fuel cell unit and a fuel cell package composed thereof.

According to the examples, the membrane module, fuel cell unit, and fuel cell package have a simplified structure and are more convenient to manufacture.

### DESCRIPTION OF ACCOMPANYING DRAWINGS

The disclosure of the examples will become more easily understandable with reference to the accompanying drawings. It will be readily understood by those skilled in the art that these accompanying drawings are for purposes of illustration only and are not intended to limit the scope of protection of the examples. Additionally, similar numerals in the figures are used to represent similar components, wherein:

FIG. 1 shows an exploded view of an existing fuel cell unit;

FIG. 2 shows a schematic view of the frames and multi-layer membrane of the fuel cell unit according to one example;

FIG. 3 shows a schematic view of the membrane module of the fuel cell unit according to one example; and

FIG. 4 shows another example of the frames of the fuel cell unit according to the examples.

### SPECIFIC EMBODIMENTS

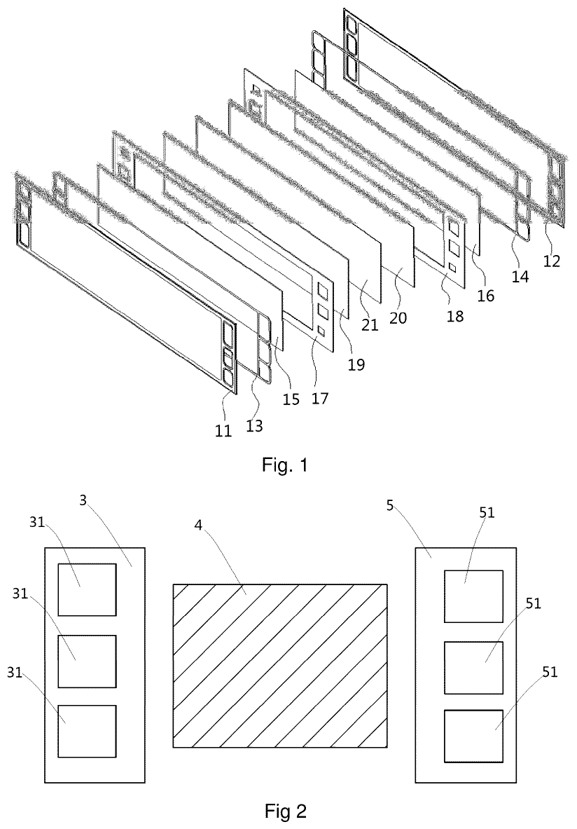

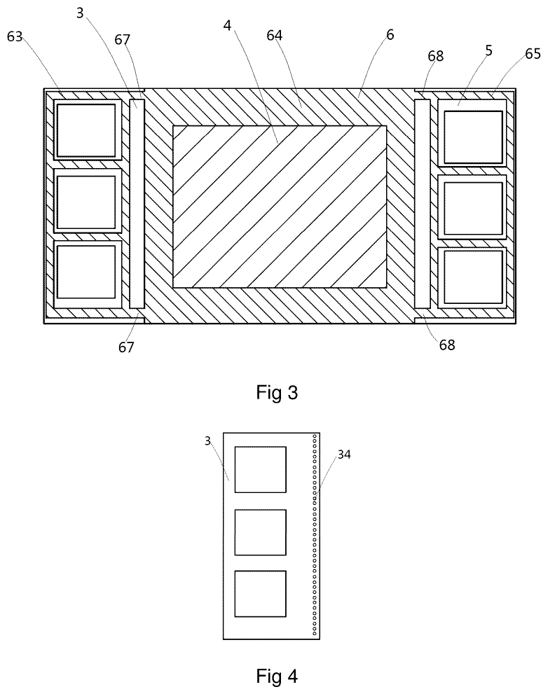

A membrane module and a fuel cell unit according to one example of the present disclosure are introduced with reference to FIG. 2 to FIG. 4. The fuel cell unit according to the example comprises a first bipolar plate and a second bipolar plate (not shown), and a membrane module between the first bipolar plate and the second bipolar plate. The membrane module comprises a multilayer membrane 4; a first frame 3 and a second frame 5 located on opposite sides (left and right sides or top and bottom sides in the figure) of the multilayer membrane 4, wherein the first frame 3 and the second frame 5 are substantially located on the same plane as the multilayer membrane 4; and an elastomeric seal 6 connecting the multilayer membrane 4, which would otherwise be separated, to the first frame 3 and the second frame 5. In the prior art shown in FIG. 1, two layers of frames 17, 18 are typically included, and an opening is provided in the middle of the frames 17, 18, with relatively low material utilization. In addition, assembling the diffusion layers 15, 16, the catalytic layers 16, 19 and the proton-exchange membrane 21 to the frames is a time-consuming and cumbersome task, and the seals 13, 14 are typically formed separately on the bipolar plates 11, 12. The fuel cell unit according to the example of the present disclosure has a higher utilization rate of the frame material. It requires only one layer of the frame material, which is thinner and generates less waste during cutting. In addition, connecting the multilayer membrane 4 to the first frame 3 and the second frame 5 by means of an elastomeric seal simplifies the process and reduces the processing difficulty.

In some examples, the multilayer membrane 4 may comprise a proton-exchange membrane, a first catalyst layer and a second catalyst layer on both sides of the proton-exchange membrane, and a first gas diffusion layer and a second gas diffusion layer on the outer sides of the first catalyst layer and second catalyst layer. In some examples, the multilayer membrane 4 may also comprise other suitable layers. In some examples, during manufacturing, the multilayer membrane, including the proton-exchange membrane, the first catalyst layer, the second catalyst layer, the first gas diffusion layer and the second gas diffusion layer, may be pre-assembled as a unit. For example, the proton-exchange membrane, the first catalyst layer, the second catalyst layer, the first gas diffusion layer, and the second gas diffusion layer may be hermetically assembled as a unit with silicone sealant, for instance, by the screen printing technique.

In some examples, the elastomeric seal 6 comprises: a central portion 64 attached to the multilayer membrane, a first end portion 63 and a second end portion 65 respectively attached to the first frame 3 and the second frame 5, with the first end portion 63 and the second end portion 65 of the elastomeric seal connected to the central portion 64. In some examples, the central portion 64 of the elastomeric seal is formed around the multilayer membrane 4. For example, as shown in the figure, the central portion 64 of the elastomeric seal is formed substantially in the shape of the Chinese character “ [symbol] ” around the multilayer membrane 4. In some examples, the central portion 64 of the elastomeric seal may also have other shapes to minimize resistance to gas or liquid flow.

In some examples, the first frame 3 and the second frame 5 each define a plurality of openings 31, 51 corresponding to fluid inlets. The first end portion 63 and the second end portion 65 of the elastomeric seal 6 are respectively formed as a sealing strip around each of the plurality of openings 31, 51 at opposing faces of the first frame 3 and the second frame 5. In the illustrated example, the first frame 3 and the second frame 5 each comprise three openings 31, 51. For example, the first frame 3 and the second frame 5 may be rectangular in shape, substantially forming the shape of the Chinese character “ [symbol] ”, with each of the three openings 31, 51 of the first frame 3 and the second frame 5 respectively corresponding to an air inlet, an air outlet, a hydrogen inlet, a hydrogen outlet, a coolant inlet, and a coolant outlet. Accordingly, the first end portion 63 and the second end portion 65 of the elastomeric seal 6 are also formed in the shape of the Chinese character “ [symbol] ”. Although the illustrated example only shows the first end portion 63 and the second end portion 65 of the elastomeric seal 6 on the front side of the first frame 3 and the second frame 5, the first end portion 63 and the second end portion 65 of the elastomeric seal 6 may have the same structure on the rear side of the first frame 3 and the second frame 5. In some examples, the first end portion 63 and the second end portion 65 of the elastomeric seal 6 are connected to the central portion 64 of the elastomeric seal via two upper and lower connecting segments 67, 68, of which, a hollow section is provided between the upper and lower connecting segments 67, 68, such that the central portion 64 of the elastomeric seal is separated from the first end portion 63 and the second end portion 65. The hollow structure may match corresponding protrusions on the bipolar plates. In some examples, the first frame and the second frame may be made of materials such as PEN (polyethylene naphthalate), PET (polyethylene terephthalate), PI (polyimide), or PMMA (polymethyl methacrylate).

In some examples, the first bipolar plate and the second bipolar plate have grooves corresponding to the first end portion 63 and the second end portion 65 of the elastomeric seal that are formed as sealing strips, such that when the first bipolar plate and the second bipolar plate are assembled, the first end portion 63 and the second end portion 65 of the elastomeric seal are embedded in the corresponding grooves. Thus, when the fuel cell unit is assembled, the membrane module is sandwiched between the two bipolar plates, and the first end portion 63 and the second end portion 65 of the elastomeric seal are compressed to achieve a seal.

In some examples, the first frame 3 and the second frame 5 may further comprise micro holes 34, such as a row of micro holes 34 along one side of the first frame 3 and the second frame 5, proximate to the multilayer membrane 4, while the first end portion 63 and the second end portion 65 of the elastomeric seal pass through the micro holes 34 of the first frame and the second frame, respectively. The elastomeric seal passing through the micro holes of the first frame and the second frame enables better connection of the elastomeric seal to the first frame 3 and the second frame 5, thereby enhancing the binding strength. In some examples, the micro holes 34 may be disposed in other suitable locations. The diameter of the micro holes 34 may be at the millimeter level, or even smaller, such as at the micrometer level, for example, a few micrometers or tens of micrometers, such as within a range of 5 micrometers to 100 micrometers.

In some examples, the elastomeric seal 6 is attached to the multilayer membrane 4, the first frame 3, and the second frame 5 through injection molding. The elastomeric seal 6 is made, for example, of a silicone material.

In another aspect, a fuel cell package comprising a stacked plurality of fuel cell units according to the above examples is also provided.

In another aspect, a manufacturing method for a membrane module is also provided, comprising the following steps: integrating the proton-exchange membrane, the first catalyst layer, and the second catalyst layer on both sides of the proton-exchange membrane, and the first gas diffusion layer and the second gas diffusion layer on the outer sides of the first catalyst layer and the second catalyst layer into a single unit to form a multilayer membrane; cutting to fabricate the first frame and the second frame; arranging the multilayer membrane, the first frame and the second frame in a mold, with the first frame and the second frame located on opposite sides of the multilayer membrane on the plane where the multilayer membrane is located; and forming the elastomeric seal on the multilayer membrane, the first frame, and the second frame by injection molding, thereby connecting the multilayer membrane with the first frame and the second frame to form the membrane module. In another aspect, a manufacturing method for a fuel cell unit is provided, comprising assembling the first bipolar plate, the second bipolar plate, and the membrane module according to the respective example, such that the membrane module is positioned between the first bipolar plate and the second bipolar plate to form the fuel cell unit.

The specific examples described above are only intended to illustrate the principles of the examples more clearly, wherein individual components are clearly shown or described to facilitate a better understanding of the principles of the examples. Without departing from the scope of the examples, various modifications or changes to the examples can be easily made by those skilled in the art. Therefore, it should be understood that these modifications or changes are all included within the scope of the patent protection of the examples.

1. A membrane module, comprising:
a multilayer membrane;
a first frame and a second frame substantially located on opposite sides of the multilayer membrane on a plane in which the multilayer membrane is located; and
an elastomeric seal connecting the multilayer membrane with the first frame and the second frame.

2. The membrane module according to claim 1, wherein the multilayer membrane comprises a proton-exchange membrane, a first catalyst layer and a second catalyst layer on both sides of the proton-exchange membrane, and a first gas diffusion layer and a second gas diffusion layer on the outer sides of the first catalyst layer and the second catalyst layer, wherein the proton-exchange membrane, the first catalyst layer, the second catalyst layer, the first gas diffusion layer and the second gas diffusion layer are configured to may be pre-assembled as a unit, and wherein the proton-exchange membrane, the first catalyst layer, the second catalyst layer, the first gas diffusion layer, and the second gas diffusion layer are hermetically assembled with silicone sealant by the a screen printing technique.

3. A membrane module according to claim 1, wherein the elastomeric seal comprises a central portion attached to the multilayer membrane, a first end portion and a second end portion respectively attached to the first frame and the second frame, with the first end portion and the second end portion of the elastomeric seal connected to the central portion, wherein the central portion of the elastomeric seal is formed around the multilayer membrane, wherein the first frame and the second frame each define a plurality of openings corresponding to fluid inlets, and wherein the first end portion and the second end portion of the elastomeric seal are respectively formed as sealing strips around each of the plurality of openings at opposing faces of the first frame and the second frame.

4. The membrane module according to claim 3, wherein the central portion of the elastomeric seal is in the shape of the Chinese character “ [symbol] ”, and the first end portion and the second end portion of the elastomeric seal are in the shape of the Chinese character “ [symbol] ” and located at opposing faces of the first frame and the second frame, wherein the first frame and the second frame are made of PEN, PET, PI, or PMMA.

5. The membrane module according to claim 4, wherein the first frame and the second frame further comprise micro holes, with the first end portion and the second end portion of the elastomeric seal respectively passing through the micro holes of the first frame and the second frame, wherein the first frame and the second frame comprise a row of the micro holes located on the side proximate to the multilayer membrane.

6. The membrane module according to claim 1, wherein the elastomeric seal is attached to the multilayer membrane, the first frame, and the second frame by injection molding.

7. A fuel cell unit, comprising:
a first bipolar plate and a second bipolar plate, and
a membrane assembly according to claim 1 located between the first bipolar plate and the second bipolar plate.

8. The fuel cell unit according to claim 7, wherein the first bipolar plate and the second bipolar plate have grooves corresponding to the first end portion and the second end portion of the elastomeric seal that are formed as sealing strips, such that the sealing strips are embedded in the corresponding grooves when the first bipolar plate and the second bipolar plate are assembled, wherein the first end portion and the second end portion are connected to the central portion of the elastomeric seal by a pair of connecting segments, respectively, with the connecting segments having a hollow portion between them, and with the first bipolar plate and the second bipolar plate having projections corresponding to the position of the hollow portion.

9. A fuel cell pack comprising a stacked plurality of fuel cell units according to claim 7.

10. A manufacturing method for a membrane module, comprising:
integrating a proton-exchange membrane, a first catalyst layer, and a second catalyst layer on both sides of the proton-exchange membrane, and a first gas diffusion layer and a second gas diffusion layer on the outer sides of the first catalyst layer and the second catalyst layer into a single unit to form a multilayer membrane;
fabricating a first frame and a second frame;
arranging the multilayer membrane and the first frame and the second frame in a mold, with the first frame and the second frame substantially located on opposite sides of the multilayer membrane on the a plane where the multilayer membrane is located; and
forming the an elastomeric seal on the multilayer membrane, the first frame, and the second frame by injection molding so as to connect the multilayer membrane with the first frame and the second frame to form the membrane module.
